(19) United States
(12) Patent Application Publication
(10) Pub. No.: US 2026/0156461 A1
(43) Pub. Date: Jun. 4, 2026

(54) ACCESS AUTHENTICATION IN WIRELESS COMMUNICATION

(71) Applicant: TP-Link Systems Inc., IRVINE, CA (US)

(72) Inventors: Renfang ZHOU, Shenzhen (CN); Yunpeng YANG, Shenzhen (CN); Junbin CHEN, Chengdu (CN)

(73) Assignee: TP-Link Systems Inc., IRVINE, CA (US)

(21) Appl. No.: 18/967,549

(22) Filed: Dec. 3, 2024

(51) Int. Cl. H04W 12/04; H04W 12/06

(52) U.S. Cl. CPC H04W 12/04; H04W 12/06

(57) ABSTRACT

This disclosure provides a method and device for access authentication in wireless communication. The method performed by a first device includes: transmitting, to a second device, a first message for initiating a handshake process between the first device and the second device, wherein the first message at least includes a first key generation parameter of the first device; receiving, from the second device, a second message as a response to the first message, wherein the second message at least includes a second key generation parameter of the second device and a checking parameter generated by the second device at least based on the first key generation parameter and the second key generation parameter; and transmitting, to the second device, a third message for confirming a success of the handshake process, in response to verifying the checking parameter of the second message.

### TECHNICAL FIELD

The present disclosure relates to wireless communications, and more specifically, to method and device for access authentication in wireless communication.

### BACKGROUND

In wireless communication systems, roaming technology is crucial for enabling seamless handovers between different access points (APs) for mobile devices. However, current roaming technologies face challenges in terms of low latency and high reliability. Especially in high-mobility scenarios, such as vehicular communications or rapidly moving user devices, these challenges are particularly significant. The traditional roaming process, which involves disconnecting from the current AP (also referred as source AP) before associating with the target AP, can cause noticeable service interruptions, thereby impacting user experience and the continuity of data transmission. To improve this, technologies such as fast transition (Fast BSS Transition, refer as FT) process have been introduced in 802.11r. The FT process aims to minimize the number of messages exchanged during roaming, thereby reducing the handover time. With four message exchanges, the FT process completes roaming and key negotiation, representing a significant improvement compared to the traditional roaming process.

Although current authentication methods with four message exchanges have made some progress in reducing the handover time and improving connection efficiency, there is still a need for further reducing latency while ensuring security, thereby achieving a more efficient and seamless connection experience, especially in high-mobility scenarios.

### SUMMARY

In view of this, the present disclosure provides a method and device for access authentication in wireless communication, which can further reduce connection latency while ensuring security.

In an aspect of the present disclosure, the present disclosure provides a method performed by a first device in wireless communication, comprising: transmitting, to a second device, a first message for initiating a handshake process between the first device and the second device, wherein the first message at least includes a first key generation parameter of the first device; receiving, from the second device, a second message as a response to the first message, wherein the second message at least includes a second key generation parameter of the second device and a checking parameter generated by the second device at least based on the first key generation parameter and the second key generation parameter; and transmitting, to the second device, a third message for confirming a success of the handshake process, in response to verifying the checking parameter of the second message.

In another aspect of the present disclosure, the present disclosure provides a method performed by a second device in wireless communication, the method comprising: receiving, from a first device, a first message for initiating a handshake process between the first device and the second device, wherein the first message at least includes a first key generation parameter of the first device; transmitting, to the first device, a second message as a response to the first message, wherein the second message at least includes a second key generation parameter of the second device and a checking parameter generated by the second device at least based on the first key generation parameter and the second key generation parameter; and receiving, from the first device, a third message for confirming a success of the handshake process, in response to verifying the checking parameter of the second message.

In yet another aspect of the present disclosure, the present disclosure provides a device in wireless communication, comprising: one or more processors; a memory coupled to at least one of the processors; and a set of computer program instructions stored in the memory, when executed by at least one of the processors, the instructions perform steps of: transmitting, to a second device, a first message for initiating a handshake process between the first device and the second device, wherein the first message at least includes a first key generation parameter of the first device; receiving, from the second device, a second message as a response to the first message, wherein the second message at least includes a second key generation parameter of the second device and a checking parameter generated by the second device at least based on the first key generation parameter and the second key generation parameter; and transmitting, to the second device, a third message for confirming a success of the handshake process, in response to verifying the checking parameter of the second message.

In yet another aspect of the present disclosure, the present disclosure provides a device in wireless communication, comprising: one or more processors; a memory coupled to at least one of the processors; and a set of computer program instructions stored in the memory, when executed by at least one of the processors, the instructions perform steps of: receiving, from a first device, a first message for initiating a handshake process between the first device and the second device, wherein the first message at least includes a first key generation parameter of the first device; transmitting, to the first device, a second message as a response to the first message, wherein the second message at least includes a second key generation parameter of the second device and a checking parameter generated by the second device at least based on the first key generation parameter and the second key generation parameter; and receiving, from the first device, a third message for confirming a success of the handshake process, in response to verifying the checking parameter of the second message.

In yet another aspect of the present disclosure, there is provided a non-transitory computer-readable storage medium storing instructions that cause a processor of a first device to: transmit, to a second device, a first message for initiating a handshake process between the first device and the second device, wherein the first message at least includes a first key generation parameter of the first device; receive, from the second device, a second message as a response to the first message, wherein the second message at least includes a second key generation parameter of the second device and a checking parameter generated by the second device at least based on the first key generation parameter and the second key generation parameter; and transmit, to the second device, a third message for confirming a success of the handshake process, in response to verifying the checking parameter of the second message.

In yet another aspect of the present disclosure, there is provided a non-transitory computer-readable storage medium storing instructions that cause a processor of a second device to: receive, from a first device, a first message for initiating a handshake process between the first device and the second device, wherein the first message at least includes a first key generation parameter of the first device; transmit, to the first device, a second message as a response to the first message, wherein the second message at least includes a second key generation parameter of the second device and a checking parameter generated by the second device at least based on the first key generation parameter and the second key generation parameter; and receive, from the first device, a third message for confirming a success of the handshake process, in response to verifying the checking parameter of the second message.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements.

FIG. 1 shows an exemplary architecture 100 of a wireless communication system;

FIG. 2 shows a conventional access authentication process 200 in roaming transition with four message exchanges;

FIG. 3 shows an exemplary schematic diagram illustrating an enhanced access authentication process 300 with three message exchanges according to an embodiment of the present disclosure;

FIGS. 4A-4B respectively show exemplary schematic diagrams illustrating enhanced access authentication processes 400A-400B in roaming transition according to an embodiment of the present disclosure;

FIGS. 5A-5B respectively show exemplary schematic diagrams illustrating enhanced access authentication processes 500A-500B in roaming transition according to an embodiment of the present disclosure;

FIG. 6 shows a conventional access authentication process 600 in SAE with four message exchanges;

FIG. 7 shows an exemplary schematic diagram illustrating an enhanced access authentication process 700 in SAE with three message exchanges according to an embodiment of the present disclosure;

FIG. 8 shows a flowchart of a computer-implemented method 800 for access authentication in wireless communication implemented at a first device according to an embodiment of the present disclosure;

FIG. 9 shows a flowchart of a computer-implemented method 800 for access authentication in wireless communication implemented at a second device according to an embodiment of the present disclosure;

FIG. 10 is an exemplary block diagram illustrating a device in accordance with some embodiments of the present disclosure.

One skilled in the art will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description refers to the accompanying drawings. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “receiving”, “transmitting”, “reassociating”, “transferring”, “requesting”, “forwarding”, “authorizing”, “establishing”, “enabling”, “sending” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner. Likewise, articles such as “a”, “an” or “the” do not represent a quantity limit, but represent an existence of at least one. Words such as “connect” and “link” are not limited to physical or mechanical connections, but may include electrical connections, whether direct or indirect.

In addition, technical features involved in different embodiments of the present disclosure described below may be combined with each other as long as no conflicts occurs therebetween.

In the present disclosure, an AP, which may be interchangeably referred to as a wireless access point (WAP), is a communication device that can communicate with a non-AP device (e.g., a station (STA) or client device) in a WLAN and that allows the non-AP device to connect to a wired network. The AP usually connects to a router (via a wired network) as a standalone device, but it can also be integrated with or employed in the router. Likewise, in the present disclosure, a non-AP device (e.g., a client device or station, which is interchangeably referred to as a STA) is a communication device that can communicate with an AP to obtain various communication services such as voice, video, packet data, messaging, broadcast, etc. The STA can be any device that contains an IEEE 820.11-conformant media access control (MAC) and physical layer (PHY) interface to the wireless medium (WM). For example, a STA may be a laptop, a desktop personal computer (PC), a personal digital assistant (PDA), an access point or a Wi-Fi phone in a WLAN environment. The STA may be fixed or mobile. In the WLAN environment, the terms “STA”, “client device”, “wireless client”, “user” and “user device” are often used interchangeably.

In the present disclosure, a STA in a WLAN may work as an AP at a different occasion, and vice versa. This is because communication devices in the context of IEEE 820.11 (Wi-Fi) technologies may include both STA hardware components and AP hardware components. In this manner, the communication devices may switch between a STA mode and an AP mode, based on actual WLAN conditions and/or requirements. In various embodiments, a non-AP device may refer to a STA in a WLAN that is not implemented as an AP.

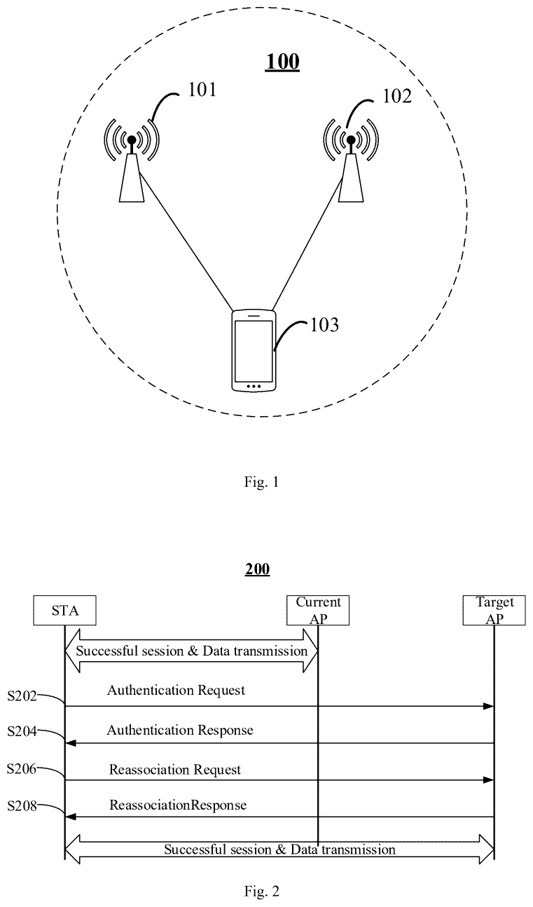

FIG. 1 shows an exemplary architecture 100 of a wireless communication system. As shown in FIG. 1, the wireless communication system includes multiple AP devices (for example, an AP device 101 and an AP device 102 in FIG. 1) and one client device 103, and can be employed in IEEE 802.11 WLAN networks. The AP device is a device that provides a service for the client device, and the client device may communicate with the AP device. The quantity of AP devices and the quantity of client devices in FIG. 1 are merely an example.

As previously discussed, the AP is capable of establishing WLAN communication with the client device 103 enabling the client devices to connect to a wired network. This permits the client device 103 to access a variety of communication services from the Internet, including voice, video, packet data, messaging, and broadcast, among others. The client device in embodiments of the present disclosure has a wireless transceiver function, may support the 802.11 series protocols, and may communicate with the AP device or another client device. After the client device 103 successfully associates with the AP through the 802.11 association procedure, data transfer between the client device 103 and the AP can commence. This allows the client device 103 to transmit and receive data packets to and from the network through the AP. The client device is any user communication device that allows a user to communicate with an AP and then communicate with a WLAN. For example, the client device may be user equipment that can be connected to a network, including but not limited to, for example, a smartphone, a tablet computer, a desktop computer, a laptop computer, a notebook computer, an ultra-mobile personal computer, a handheld computer, a netbook, a personal digital assistant, and other internet-capable devices, may be an internet of things node in the internet of things, or may be a vehicle-mounted communication apparatus in the internet of vehicles. The AP device in embodiments of this application is an apparatus that serves the client device, and may support the 802.11 series protocols. For example, the AP device may be a communication entity such as a communication server, a router, a switch, or a bridge, or the AP device may include various forms of macro base stations, micro base stations, relay stations, and the like. Certainly, the AP device may alternatively be chips and processing systems in the various forms of devices, to implement the method and the function in embodiments of the present disclosure.

The architecture presented in FIG. 1 is only illustrative and does not impose any limitations on any embodiment of the present disclosure. Multiple APs in the WLAN network can serve specific sets of associated client devices, and depending on application requirements and overall network constraints, the number of client devices in each serving set can be more than one client device as depicted.

In IEEE 802.11be standard, the Multi-Link Operation (MLO) technology is introduced, in which a single device, namely a Multi-Link (ML) device (MLD), implements a ML logical entity made of a plurality of stations. The stations can use 802.11 protocols to communicate with stations of another MLD over respective communication links, thereby establishing a multilink communication session to exchange data units (e.g., MPDUs). Therefore, one MLD can transmit messages over multiple links simultaneously to improve throughput. Herein, “multilink device”, “ML device” (MLD), “multilink logical entity”, “ML logical entity” (MLE), “multilink set” and “ML set” may be used interchangeably.

To reduce traffic interruption time when a client device transition between APs in traditional Wi-Fi roaming mechanisms, Fast Basic Service Set (BSS) Transition (FT) roaming mechanism was originally proposed in IEEE 802.11r Amendment with two approaches: Over-the-Air and Over-the-DS. 802.11r (also known as Fast BSS Transition, or FT) completes roaming and key negotiation using four message exchanges, representing a significant improvement compared to the traditional roaming process. As an example, in the manner of Over-the-Air, these four message exchanges may include: (1) Authentication Request: when the STA decides to transition to the target AP, it may send an authentication request to the target AP; (2) Authentication Response: the target may respond with an authentication response, providing the keys and configuration information required for roaming; (3) Reassociation Request: the STA may generate a reassociation request and determine that the time between the authentication request and the reassociation request is below a time threshold, allowing the STA to perform reassociation to the target AP, then the STA may send the reassociation request to the target AP; and (4) Reassociation Response: The target AP may respond with a reassociation response, allowing for the STA to establish a communication session with the target AP.

FIG. 2 shows a conventional access authentication process 200 in roaming transition with four message exchanges. As shown in FIG. 2, the STA is initially associated with an AP device, i.e., the current AP in FIG. 2, and it proceeds with successful session and data transmission with the current AP, so as to communication with the network.

When the STA determines that it needs to transition to another AP device, i.e., the target AP in FIG. 2, due to various reasons, it will transmit a roaming authentication request directly to the target AP, as shown at step S202 of FIG. 2, i.e., in the manner of Over-the-Air. For example, the frame structure of the roaming authentication request may be as Authentication-Request (FTAA, RSNIE[PMKR0Name], MDIE, FTIE [SNonce, R0KH-ID]). The elements in the Authentication-Request frame and their required contents shall be as given in IEEE Std 802.11r Part11 Section 13.8.2 (FT authentication sequence: contents of first message), the related description will be omitted herein for conciseness.

Upon receiving the roaming authentication request, the target AP may generate and install a corresponding security key (such as a pairwise transient key (PTK) according to information contained therein and the security association key PMK-R1, and initiate a reassociation timer simultaneously. Then, as shown at step S204 of FIG. 2, the target AP transmits a roaming authentication response to the STA. For example, the frame structure of the roaming authentication response may be as Authentication-Response (FTAA, RSNIE[PMKR0Name], MDIE, FTIE [ANonce, SNonce, R1KH-ID, R0KH-ID]). The elements in the frame, and their required contents, shall be as given in IEEE Std 802.11r Part11 Section 13.8.3 (FT authentication sequence: contents of second message), the related description will be omitted herein for conciseness.

If the STA does not receive a response to the Authentication-Request frame, it may reissue the request following the restrictions given for Authentication frames in 11.3 (STA authentication and association). If the Status Code field value returned by the target AP is SUCCESS, the STA and target AP transition to State 2 (as defined in IEEE Std 802.11r Part11 Section 11.3 (STA authentication and association)); the STA may continue with reassociation (as defined in IEEE Std 802.11r Part11 Section 13.7.1 (FT reassociation in an RSN)).

Upon receiving the roaming authentication response, the STA may generate and install the respective security key PTK. Then, the STA transmits a roaming reassociation request to the target AP, as shown at step S206 of FIG. 2. For example, the frame structure of the roaming reassociation request may be as Reassociation-Request (RSNIE[PMKR1Name], MDIE, FTIE [MIC, ANonce, SNonce, R1KH-ID, R0KH-ID], RIC-Request). Further, the element RIC-Request is optionally included in the Reassociation-Request frame.

Upon receiving the roaming reassociation request, the target AP turns off the reassociation timer and transmits a roaming reassociation response to the STA, as shown at step S208 of FIG. 2. Upon receiving the roaming reassociation response, the STA completes the roaming, and thus can proceed with successful session and data transmission with the target AP, so as to communication with the network. The PTKs generated by the STA and the target AP would be used in the subsequent communication therebetween. For example, the frame structure of the roaming reassociation response may be as Reassociation-Response (RSNIE[PMKR1Name], MDIE, FTIE [MIC, ANonce, SNonce, R1KH-ID, R0KH-ID], GTK[N], RIC-Response). Further, the element RIC-Response is optionally included in the Reassociation-Response frame.

Similar as the Over-the-Air roaming process shown in FIG. 2, the Over-the-DS roaming process (not shown) also include the steps S206-S208 of FIG. 2, the differences are the steps S202-S204. Specifically, in the Over-the-DS (over the distribution system) roaming process, the STA transmits the FT request to the current AP, which relays the FT request to the target AP, and similarly, the target AP transmits the FT response to the current AP, which relays the FT response to the STA.

As compared with the traditional roaming process, current FT roaming technologies in 802.11r have made some progress in reducing the handover time and improving roaming efficiency, there still requires improvements for further reducing latency while ensuring security, thereby achieving a more efficient and seamless roaming experience, especially in high-mobility scenarios. In order to further decrease the access latency, the present disclosure proposes an enhancement access authentication, which addresses the transition delay issue by reducing the number of messages to be exchanged.

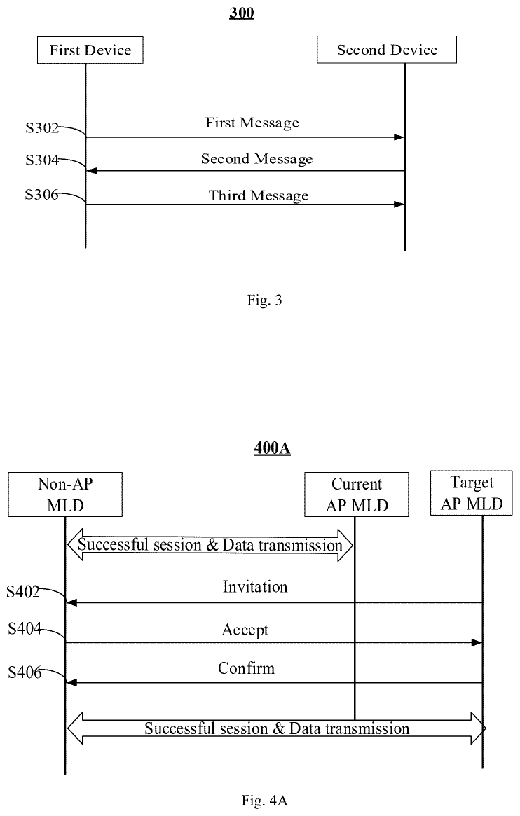

FIG. 3 shows an exemplary schematic diagram illustrating an enhanced access authentication process 300 with three message exchanges according to an embodiment of the present disclosure.

As shown in FIG. 3, according to an embodiment of the present disclosure, there may be a first device and a second device. As an example, the first device may be a non-AP device (i.e., the STA in FIG. 2), and the second device may be a target AP device (i.e., the target AP in FIG. 2), or vice versa.

Upon determining that an access authentication is required due to various reasons, the first device may initiate a handshake process with three message exchanges, which can also be referred to 3-way handshake process. Through the three messages, the first and second devices can exchange information required for authentication or association, such as key generation parameter. The 3-way handshake process may be performed as steps S302-306.

At step S302, the first device may transmit to the second device, a first message for initiating a handshake process between the first and second device, while requiring the authentication. Along with the authentication request, a first key generation parameter generated by the first device is provided to the second device.

Upon receiving the first message, the second device may generate a checking parameter based on the first key generation parameter received from the first message and its own second key generation parameter. Further, the second device may generate a corresponding security key such as the Pairwise Transient Key (PTK) at least based on the first key generation parameter from the first message and its own second key generation parameter. For example, the PTK can be generated based on PMK, the first and second key generation parameters, and the MAC addresses of the STA and the target AP device, wherein the PMK is a pairwise master key occupied in the STA and the target AP device. The second device may include at least the second key generation parameter and the checking parameter in a second message. Then, at step S304, the second device can transmit the second message back to the first device in response to the request and provide the second key generation parameter and the checking parameter.

Upon receiving the second message, the first device may also generate a peer checking parameter at least based on the second key generation parameter from the second message and its own first key generation parameter, and determine whether the checking parameter generated by the first device on its own and the checking parameter from the second devices are matched. It shall be understood, the checking parameter is for checking the integrity of the transmitted second message and checking whether the generated PTKs by the first and second devices are matched. The generated PTKs being matched means the handshake process is successful, and the generated PTK can be installed at respective device and used for subsequent communication. Further, the first device may generate and install the security key PTK at least based on its own first key generation parameter and the second key generation parameter from the second message. If the checking parameters of the first and second devices are matched, at step S306, the first device may transmit a third message for confirming a success of the handshake process. The third message may include the first and second key generation parameters. Further, there may be an optional additional checking parameter generated by the first device included in the third message.

As an example, the additional checking parameter may be calculated based on the first and second key generation parameters for integrity checking of the transmitted third message. Following this confirmation, the first and second devices can proceed with successful session and data transmission using respective PTKs. The PTKs of two devices can be identical or matched, such that the data transmission therebetween cannot be acquired by any other unauthenticated devices.

According to the embodiment shown in FIG. 3, the access authentication and key negotiation can be achieved by merely with three message exchanges in the process 300. Comparing with the conventional authentication process with four message exchanges, the process 300 of this present disclosure reduces the number of message exchanges, decreases the connection latency, thereby improving connection efficiency and achieving a more efficient and seamless connection experience.

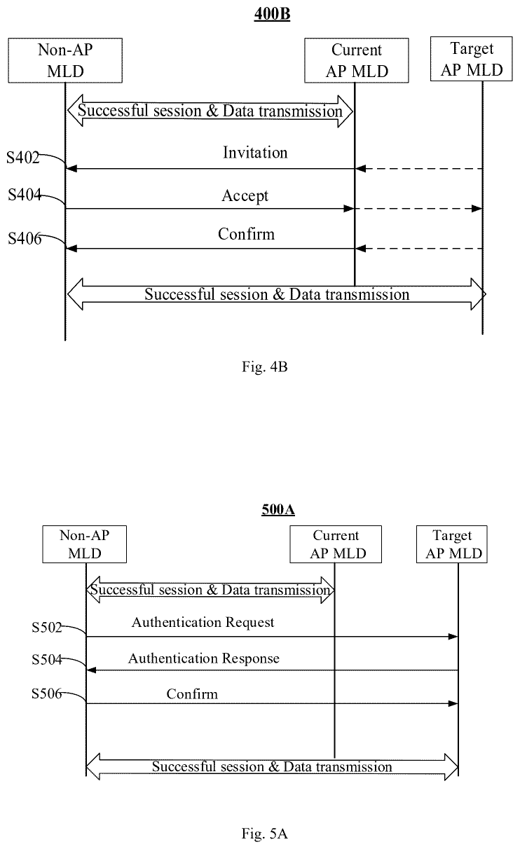

FIGS. 4A-4B respectively show exemplary schematic diagrams illustrating enhanced access authentication processes 400A-400B in roaming transition according to an embodiment of the present disclosure.

As shown in FIGS. 4A-4B, according to an embodiment of the present disclosure, there are a non-AP MLD, a current AP MLD, a target AP MLD. As described below, the handshake messages can be directly communicated between the non-AP MLD and the target AP MLD (as shown in FIG. 4A). Alternatively, the handshake messages can be indirectly communicated via a distributed system (DS) (as shown in FIG. 4B). In this embodiment, the first device is the target AP MLD, and the second device is the non-AP MLD connected to the current AP MLD. The non-AP MLD, the current AP MLD and the target AP MLD may be communication connected with each other, and the non-AP MLD may be communication connected to any of the current AP MLD and the target AP MLD. Like the roaming process described with reference to FIG. 2, the non-AP MLD, which is similar as the STA in FIG. 2, is initially associated with (for example, wirelessly connected to) the current AP MLD, which is similar as the current AP in FIG. 2. After the target AP MLD, which is similar as the target AP in FIG. 2 detects that the non-AP MLD enters into its coverage area, it initiates an access authentication process, as shown at steps S402-S406 of FIGS. 4A-4B.

In an example embodiment, at step S402, the target AP MLD may transmit to the non-AP MLD, an invitation message (i.e., the first message in FIG. 3) for inviting the non-AP MLD to transition to the target AP MLD and providing a first key generation parameter.

As an example, the invitation message includes a first FTIE (Fast Transition Information Element), and the first key generation parameter to be exchanged is included in the first FTIE. For example, the frame structure of the invitation message may be as Invitation (FTAA, RSNIE[PMKR0Name], MDIE, FTIE [ANonce, R1KH-ID, R0KH-ID]). For example, the first key generation parameter may be ANonce or A public key, wherein the ANonce refers to a Nonce generated by the target AP MLD, and the A public key refers to a public key generated by the target AP MLD. It shall be noted, the Nonce or public key is only illustrative and does not impose any limitations on any embodiment of the present disclosure. The key generation parameter may also be any other parameter or element for key generation.

Upon receiving the invitation message, the non-AP MLD may generate and install a corresponding security key PTK at least based on the first key generation parameter (such as ANonce or A public key) contained in the invitation message and the second key generation parameter hold by the non-AP MLD itself. For example, the second key generation parameter may be SNonce or S public key, wherein the SNonce refers to a Nonce generated by the STA (such as the non-AP MLD shown in FIGS. 4A-4B), and the S public key refers to a public key generated by STA (such as the non-AP MLD shown in FIGS. 4A-4B). The non-AP MLD may also generate a checking parameter (such as MIC (message Integrity Code)) for checking whether the PTKs respectively generated by the non-AP MLD and the AP MLD are matched. For example, the MIC included in the accept message to be sent may be calculated based on concatenation of the following data: initiator device (such as the target AP MLD shown in FIGS. 4A-4B) MAC address, responder STA (such as the non-AP MLD shown in FIGS. 4A-4B) MAC address, Transaction Sequence number, Content of the RSNIE, Content of the MDIE, Content of the FTIE, and Content of the RIC-Request (if present) of the accept message to be sent. For another example, the MIC included in the accept message to be sent may be further encrypted by the generated final key (such as the checked available PTK). Further, the non-AP MLD may contain the second key generation parameter and checking parameter in an accept message (i.e., the second message in FIG. 3). Then, at step S404, the non-AP MLD may transmit the accept message back to the target AP MLD in response to the invitation and proving the generated parameters needed to be exchanged.

As an example, the accept message includes a second FTIE, and the first key generation parameter (such as SNonce or S public key) to be exchanged is included in the second FTIE. For example, the frame structure of the accept message may be as Accept (FTAA, RSNIE[PMKR1Name], MDIE, FTIE [MIC, ANonce, SNonce, R1KH-ID, R0KH-ID], RIC-Request). It shall be noted, the MIC is merely an example for the checking parameter, and it is not limited, and the checking parameter can adopt any other ways for key checking. Moreover, the element of the RIC-request may be optionally included in the accept message.

Upon receiving the accept message, the target AP MLD may generate and install the security key PTK at least based on its own first key generation parameter (such as ANonce or A public key) and the second key generation parameter (such as SNonce or S public key) from the accept message. The target AP MLD may also generate peer checking parameter (such as MIC), and determine whether the checking parameters generated by the non-AP MLD and the target AP MLD are matched. If matched, the PTKs generated by the two devices can be used for security communication therebetween and the handshake process is successful. In this case, at step S406, the target AP MLD may transmit a confirm message (i.e., the third message in FIG. 3) for confirming a success of the handshake process. Following this confirmation, the target AP MLD and the non-AP MLD can proceed successful session and data transmission through the checked available PTKs.

As an example, the confirm message includes a third FTIE, and the first and second key generation parameters and the checking parameter are included in the third FTIE. For example, the frame structure of the confirm message may be as Confirm (RSNIE[PMKR1Name], MDIE, FTIE [MIC, ANonce, SNonce, R1KH-ID, R0KH-ID], GTK[N], RIC-response). For example, the MIC included in the confirm message to be sent may be calculated based on the concatenation of the following data: initiator device (such as the target AP MLD shown in FIGS. 4A-4B) MAC address, responder STA (such as the non-AP MLD shown in FIGS. 4A-4B) MAC address, Transaction Sequence number, Content of the RSNIE, Content of the MDIE, Content of the FTIE, and Content of the RIC-Response (if present) of the confirm message to be sent. Similarly, for another example, the MIC included in the confirm message to be sent may be further encrypted by the generated key (such as the checked available PTK). It shall be noted, the MIC is merely an example for the checking parameter, and it is not limited, and the checking parameter can adopt any other ways for key checking. Moreover, the element of the RIC-response may be optionally included in the accept message, if there is a RIC-request in the accept message.

As an example embodiment, referring to FIG. 4A, the invitation message, the accept message and the confirm message are directly communicated between the first device and the second device, based on an over-the-air protocol.

As an example embodiment, referring to FIG. 4B, the invitation message, the accept message and the confirm message are indirectly communicated between the first device and the second device via an intermediate device in a distributed system, based on an over-the-distribution system protocol.

According to the embodiment shown in FIGS. 4A-4B, the processes 400A-400B can achieve authentication and reassociation with only three message exchanges. Accordingly, the reduced number of message exchanges enables lower handover latency and higher connection efficiency, especially in high-mobility scenarios. Moreover, unlike the conventional FT roaming process, the processes 400A-400B can be initiated by the target AP MLD instead of by the non-AP MLD, which enhances the flexibility of the FT roaming process.

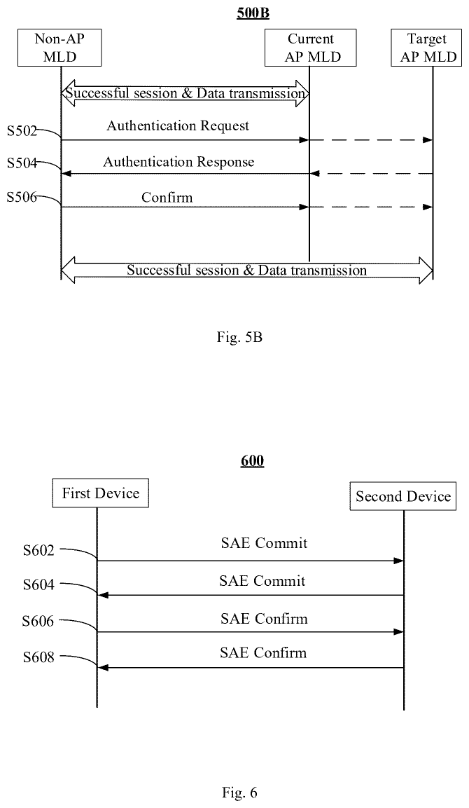

FIGS. 5A-5B respectively show exemplary schematic diagrams illustrating enhanced access authentication processes 500A-500B in roaming transition according to an embodiment of the present disclosure.

As shown in FIGS. 5A-5B, according to an embodiment of the present disclosure, there are a non-AP MLD, a current AP MLD, a non-AP MLD. As described below, the handshake messages can be directly communicated between the non-AP MLD and the target AP MLD (as shown in FIG. 5A). Alternatively, the handshake messages can be indirectly communicated via a DS (as shown in FIG. 5B). In this embodiment, the first device is the non-AP MLD connected with the current AP device, and the second device is the target AP device. The non-AP MLD, the current AP MLD and the non-AP MLD may be communication connected with each other, and the non-AP MLD may be communication connected to any of the current AP MLD and the non-AP MLD. Like the roaming process described with reference to FIG. 2, the non-AP MLD, which is similar as the STA in FIG. 2, is initially associated with (for example, wirelessly connected to) the current AP MLD, which is similar as the current AP in Fig. After the non-AP MLD requires to transition to the non-AP MLD, which is similar as the target AP in FIG. 2, it initiates a roaming transition process, as shown at steps S502-S506 of FIGS. 5A-5B.

In an example embodiment, at step S502, the non-AP MLD may transmit to the target AP MLD, an authentication request message (i.e., the first message in FIG. 3) for requesting transition to the target AP MLD and providing a first key generation parameter to the target AP MLD.

As an example, the authentication request message includes a first FTIE, and the first key generation parameter (such as ANonce or A public key) is included in the first FTIE. For example, the frame structure of the authentication request message may be as Authentication-Request (FTAA, RSNIE[PMKR0Name], MDIE, FTIE [SNonce, R0KH-ID]). It shall be noted, the Nonce or public key is only illustrative and does not impose any limitations on any embodiment of the present disclosure. The key generation parameter may also be any other parameter or element for key generation. Moreover, the element of the RIC-request may be optionally included in the authentication request message.

Upon receiving the authentication request message, the target AP MLD may generate a second key generation parameter, and generate and install a corresponding security key PTK at least based on the first key generation parameter (such as ANonce or A public key) contained in the authentication request message and the second key generation parameter (such as SNonce or S public key) hold by the target AP MLD itself. Further, the target AP MLD may also generate a checking parameter (such as MIC), and contain the parameters in an authentication response message (i.e., the second message in FIG. 3). Then, at step S504, the target AP MLD may transmit the authentication response back to the non-AP MLD in response to the request and proving the parameters needed to be exchanged.

As an example, the authentication response message includes a second FTIE, and the first key generation parameter (such as SNonce or S public key) to be exchanged is included in the second FTIE. For example, the frame structure of the authentication response message may be as Authentication-Response (FTAA, RSNIE[PMKR0Name], MDIE, FTIE [MIC, SNonce, ANonce, R1KH-ID, R0KH-ID], GTK[N], RIC-response). For example, the MIC included in the authentication response message to be sent may be calculated based on the concatenation of the following data: initiator device (such as the non-AP MLD shown in FIGS. 5A-5B) MAC address, responder STA (such as the target AP MLD shown in FIGS. 5A-5B) MAC address, Transaction Sequence number, Content of the RSNIE, Content of the MDIE, Content of the FTIE, and Content of the RIC-Response (if present) of the authentication response message to be sent. For another example, the MIC included in the authentication response message to be sent may be further encrypted by the generated final key (such as the checked available PTK). It shall be noted, the MIC is merely an example for the checking parameter, and it is not limited, and the checking parameter can adopt any other ways for key checking. Moreover, the element of the RIC-response may be optionally included in the accept message, if there is a RIC-request in the accept message.

Upon receiving the authentication response message, the non-AP MLD may generate and install the security key PTK at least based on its own first key generation parameter (such as ANonce or A public key) and the second key generation parameter (such as SNonce or S public key) from the authentication response message. The non-AP MLD may also generate another checking parameter (such as MIC), and determine whether the checking parameters generated by the non-AP MLD and the target AP MLD are matched. If matched, the PTKs generated by the two devices are available for security communication therebetween and the handshake process is successful. In this case, the non-AP MLD may transmit a confirm message (i.e., the third message in FIG. 3) for confirming a success of the handshake process at step S506. Following this confirmation, the non-AP MLD and the target AP MLD devices can proceed successful session and data transmission through the checked available PTKs.

As an example, the confirm message includes a third FTIE, and the first and second key generation parameters and the checking parameter are included in the third FTIE. For example, the frame structure of the confirm message may be as Confirm (RSNIE[PMKR1Name], MDIE, FTIE [MIC, ANonce, SNonce, R1KH-ID, R0KH-ID]). For example, the MIC included in the confirm message to be sent may be calculated based on the concatenation of the following data: initiator device (such as the non-AP MLD shown in FIGS. 5A-5B) MAC address, responder STA (such as the target AP MLD shown in FIGS. 5A-5B) MAC address, Transaction Sequence number, Content of the RSNIE, Content of the MDIE, Content of the FTIE of the confirm message to be sent. For another example, the MIC included in the authentication response message to be sent may be further encrypted by the generated final key (such as the checked available PTK). It shall be noted, the MIC is merely an example for the checking parameter, and it is not limited, and the checking parameter can adopt any other ways for key checking.

As an example embodiment, referring to FIG. 5A, the authentication request message, the authentication response message and the confirm message are directly communicated between the first device and the second device, based on an over-the-air protocol.

As an example embodiment, referring to FIG. 5B, the authentication request message, the authentication response message and the confirm message are indirectly communicated between the first device and the second device via an intermediate device in a distributed system, based on an over-the-distribution system protocol.

According to the embodiment shown in FIGS. 5A-5B, the processes 500A-500B can achieve authentication and reassociation with only three message exchanges. Accordingly, the reduced number of message exchanges enables lower handover latency and higher connection efficiency, especially in high-mobility scenarios.

An enhanced Fast Transition roaming process with a three-way handshake mechanism has been descried above according to various embodiments. It should be noted that the various embodiments have been presented for purposes of illustration, but are not intended to be exhaustive or limited to the embodiments disclosed. For example, in addition of FT transition, this three-way handshake mechanism can be further extended to any access authentication or key negotiation processes, such as FILS authentication and SAE authentication, and so on. The concept of three-way handshake mechanism applied in SAE will be described as below as an example.

Simultaneous authentication of equals (SAE) employs finite field cryptography to prove knowledge of a shared password. SAE authentication is performed prior to association and a STA can take advantage of the fact that it can be IEEE 802.11 authenticated to many APs simultaneously by completing the SAE protocol with any number of APs while still being associated to another AP. RSNA security can be established after association using the resulting shared key. Similarly, conventional SAE authentication also utilizes four message exchanges. Thus, there is still a need for further reducing latency while ensuring security.

FIG. 6 shows a conventional access authentication process 600 in SAE with four message exchanges.

As shown in FIG. 6, there are a first device and a second device. For example, the first device may be a non-AP device (i.e., the STA in FIG. 2), and the second device may be an AP device (i.e., the current AP or the target AP in FIG. 2), or vice versa. Upon the non-AP device determining that an access authentication or key negotiation is needed, it initiates a handshake process.

At step S602, the non-AP device may transmit to the target AP, an SAE commit request message for requesting to commit to the AP and providing a first key generation parameter to the AP. For example, the first key generation parameter may be a U public key generated by the non-AP device. The U key refers to the key related to the user for conducting secure communication and authentication.

Upon receiving the SAE commit request message, the AP may generate and contain a second key generation parameter in a SAE commit response message. For example, the second key generation parameter may be a V public key. The V key refers to the key related to the vehicle for conducting secure communication and authentication. Then, at step S704, the AP may transmit the SAE commit response back to the non-AP device in response to the SAE commit request.

Upon receiving the SAE commit response message, the non-AP device may generate and install the communication key at least based on its own first key generation parameter (such as U public key) and the second key generation parameter (such as V public key) from the SAE commit response message. The non-AP device may also generate and contain a checking parameter (such as Hash operation for the communication key) in a SAE confirm request message. Then, at step S706, the AP may transmit the SAE confirm request message to the AP.

Upon receiving the SAE confirm request message, the AP may generate and install its communication key at least based on its own first key generation parameter (such as U public key) and the second key generation parameter (such as V public key) from the SAE commit response message. The AP MLD may also generate and contain a checking parameter (such as Hash operation for the communication key) in a SAE confirm request message. Then, the AP determines whether the checking parameters generated by the non-AP device and the AP are matched, which means whether the communication keys generated by the two devices are available for security communication between the two devices. If it is determined that the checking parameters are matched, the non-AP device may transmit a SAE confirm response message for confirming a success of the handshake process at step S608, and thus the authentication is successful.

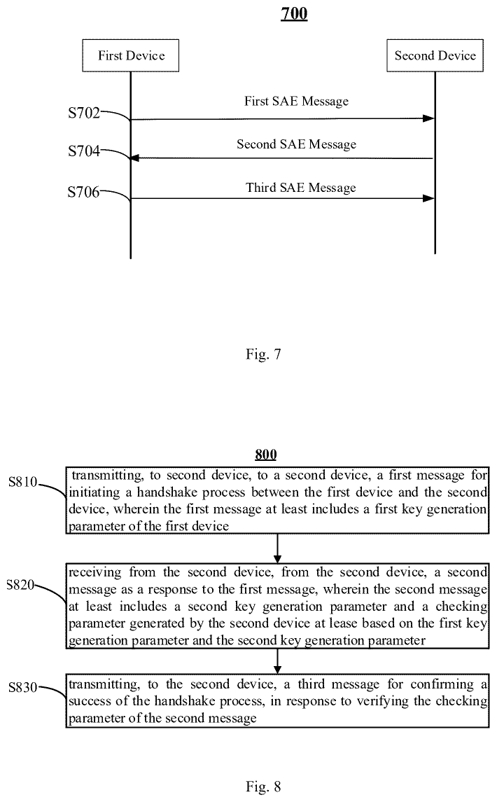

FIG. 7 shows an exemplary schematic diagram illustrating an enhanced access authentication process 700 in SAE with three message exchanges according to an embodiment of the present disclosure.

As shown in FIG. 7, according to an embodiment of the present disclosure, there are a first device and a second device. For example, the first device may be a non-AP device (i.e., the STA in FIG. 2), and the second device may be an AP device (i.e., the current AP or the target AP in FIG. 2), or vice versa. For another example, the first and second devices may be both AP device (i.e., the current AP or the target AP in FIG. 2). Upon the non-AP device determining that an access authentication or key negotiation is needed, it initiates a handshake process with three message exchanges, which can also be referred to 3-way handshake process.

In an example embodiment, at step S702, the non-AP device may transmit to the target AP, a first SAE message. Similar as the commit request message shown in FIG. 6, the first SAE message is for requesting to commit to the AP and providing a first key generation parameter to the AP. For example, the first key generation parameter may be U public key generated by the non-AP device.

Upon receiving the first SAE message, the AP may generate and install a corresponding communication key at least based on the first key generation parameter (such as U public key) contained therein and the second key generation parameter (such as V public key) generated by the AP itself. The AP may also generate a second key generation parameter and a checking parameter, and contain the generated parameters in a second SAE message. For example, the checking parameter may be generated by Hash operation for the communication key. Then, at step S704, the AP may transmit the second SAE message back to the non-AP device. Unlike the SAE commit response message shown in FIG. 6, in addition as a response to the first SAE message, the second SAE message may further provide the second key generation parameter and the checking parameter used for confirmation.

Upon receiving the second SAE message, the non-AP device may generate and install the communication key at least based on its own first key generation parameter (such as U public key) and the second key generation parameter (such as V public key) from the second SAE message. The non-AP device may also generate another checking parameter (such as Hash operation for the communication key), and determine whether the checking parameters generated by the non-AP device and the AP are matched, which means whether the communication keys generated by the two devices are identical for security communication between the two devices. If it is determined that the checking parameters are matched, the non-AP device may transmit a third SAE message for confirming a success of the handshake process at step S706, and thus the authentication is successful.

It shall be noted, hash operation is merely an example generation form of the checking parameter, any other form of operation can be also adopted. Besides, the U public key or the V public key is also as an example of the key generation parameter, and the key generation parameter may also be any other parameter or element for key generation.

According to the embodiment shown in FIG. 7, the SAE authentication process 700 can achieved merely with three message exchanges, thereby reducing the number of message exchanges and further decreasing the connection latency during the SAE authentication.

FIG. 8 shows a flowchart of a computer-implemented method 800 for access authentication in wireless communication implemented at a first device according to an embodiment of the present disclosure. Unlike the conventional 4-way handshake mechanism, the non-AP device and the AP device can exchange information required for authentication (such as key generation element) through only three messages, thereby further reduce the connection latency.

The detailed description of method 800 can refer to the content described in the above with respect to FIGS. 1-7. For example, the method 800 can be executed in the architecture described with respect to FIGS. 1-7 and according to the interactions among a non-AP device (such as a client device), a current AP device and a target AP device during roaming using the enhanced roaming mechanism as described with respect to FIGS. 1-7. In addition, each step of method 800 can be performed by one or more processing units, such as central processing unit (CPU) of the target AP device.

With reference to FIG. 8, method 800 comprises steps S810-S830. While an access authentication is needed, at step S810, the first device may transmit, to second device, to a second device, a first message for initiating a handshake process between the first device and the second device, wherein the first message at least includes a first key generation parameter of the first device.

At step S820, the first device may receive from the second device, from the second device, a second message as a response to the first message, wherein the second message at least includes a second key generation parameter of the second device and a checking parameter generated by the second device at least based on the first key generation parameter and the second key generation parameter.

At step S830, the first device may transmit, to the second device, a third message for confirming a success of the handshake process, in response to verifying the checking parameter of the second message.

In accordance with some embodiments, the first device may be a target point (AP) device, and the second device may be a non-AP device connected with a source AP device different from the target AP device. The method 800 may further comprise: detecting whether the non-AP device enters into a coverage area of the target AP device, wherein the first message is transmitted in response to detecting that the non-AP device enters into the coverage area of the target AP device.

In some exemplary embodiments, the first message may be an invitation message for inviting the non-AP device to transition from the source AP device to the target AP device through the handshake process therebetween. The second message may be an accept message for accepting the invitation. Further, the third message may be a confirm message for confirming a success of the transition.

In some exemplary embodiments, the invitation message may include a first Fast Transition Information Element (FTIE) at least including the first key generation parameter. The accept message may include a second FTIE at least including the first and second key generation parameters and the checking parameter. Further, the confirm message may include a third FTIE at least including the first and second key generation parameters. Further, the third FTIE may optionally include an additional checking parameter generated by the first device.

In accordance with some embodiments, the first device may be a non-access point (non-AP) device connected with a source AP device, and the second device may be a target AP device, and the method may further comprise: detecting whether a transition from the source AP device to the target AP device is needed, wherein the first message is transmitted in response to detecting that the transition from the source AP device to the target AP device is needed.

In some exemplary embodiments, the first message may be an authentication request message for requesting the transition from the source AP device to the target AP device. The second message may be an authentication response message for responding to the authentication request message. Further, the third message may be an confirm message for confirming a success of the transition.

In some exemplary embodiments, the authentication request message may include a first Fast Transition Information Element (FTIE) at least including the first key generation parameter. The authentication response message may include a second FTIE at least including the first and second key generation parameters and the checking parameter. Further, the confirm message may include a third FTIE including the first and second key generation parameters. Further, the third FTIE may optionally include an additional checking parameter generated by the first device.

In accordance with some embodiments, verifying the checking parameter of the second message may include: determining whether the checking parameter of the second message matches with another checking parameter generated by the first device at least based on the first and second key generation parameter key generation parameters.

In accordance with some embodiments, the first and second key generation parameters may be used to generate a first communication key at the first device and generate a second communication key at the second device, and wherein the first and second communication keys may be respectively installed in the first and second devices for subsequent communication between the first and second devices.

In some exemplary embodiments, the checking parameter may be an integrity checking code (MIC) for checking whether the first and second communication keys are matched.

In accordance with some embodiments, the first key generation parameter may be a first Nonce of the first device, and the second key generation parameter may be a second Nonce of the second device.

In accordance with some embodiments, the first key generation parameter may be a first public key of the first device, and the second key generation parameter may be a second public key of the second device.

In accordance with some embodiments, the first message, the second message and the third message may be directly communicated between the first device and the second device, based on an over-the-air protocol.

In accordance with some embodiments, the first message, the second message and the third message may be communicated between the first device and the second device via an intermediate device connected to one of the first and second devices, based on an over-the-distribution system protocol.

In accordance with some embodiments, wherein the first and the second devices are peer-to-peer devices, the handshake process may be initiated by the first device for Simultaneous Authentication of Equals (SAE) authentication between the first and the second devices.

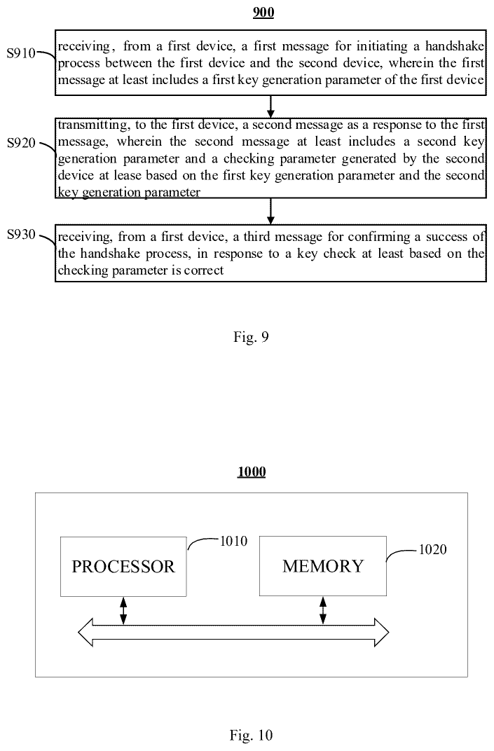

FIG. 9 shows a flowchart of a computer-implemented method 800 for access authentication in wireless communication implemented at a second device according to an embodiment of the present disclosure.

The detailed description of method 900 can refer to the content described in the above with respect to FIGS. 1-7. For example, the method 900 can be executed in the architecture described with respect to FIGS. 1-7 and according to the interactions among a client device, a current AP device and a target AP device during roaming using the enhanced roaming mechanism as described with respect to FIGS. 1-7. In addition, each step of method 900 can be performed by one or more processing units, such as central processing unit (CPU) of the current AP device.

With reference to FIG. 9, method 900 comprises steps S910-S930. While an access authentication is needed, at step S910, the second device may receive from a first device, a first message for initiating a handshake process between the first device and the second device, wherein the first message at least includes a first key generation parameter of the first device.

At step S920, the second device may transmit to the first device, a second message as a response to the first message, wherein the second message at least includes a second key generation parameter of the second device and a checking parameter generated by the second device at least based on the first key generation parameter and the second key generation parameter.

At step S930, the second device may receive from the first device, a third message for confirming a success of the handshake process, in response to verifying the checking parameter of the second message.

In accordance with some embodiments, the first device may be a target point (AP) device, and the second device may be a non-AP device connected with a source AP device different from the target AP device. The first message is received in case that the non-AP device enters into a coverage area of the target AP device.

In some exemplary embodiments, the first message may be an invitation message for inviting the non-AP device to transition from the source AP device to the target AP device through the handshake process therebetween. The second message may be an accept message for accepting the invitation. Further, the third message may be a confirm message for confirming a success of the transition.

In some exemplary embodiments, the invitation message may include a first Fast Transition Information Element (FTIE) at least including the first key generation parameter. The accept message may include a second FTIE at least including the first and second key generation parameters and the checking parameter. Further, the confirm message may include a third FTIE at least including the first and second key generation parameters. Further, the third FTIE may optionally include an additional checking parameter generated by the first device.

In accordance with some embodiments, the first device may be a non-access point (non-AP) device connected with a source AP device, and the second device may be a target AP device. The first message is received in case that a transition from the source AP device to the target AP device is needed for the non-AP device.

In some exemplary embodiments, the first message may be an authentication request message for requesting the transition from the source AP device to the target AP device. The second message may be an authentication response message for responding to the authentication request message. Further, the third message may be an confirm message for confirming a success of the transition.

In some exemplary embodiments, the authentication request message may include a first Fast Transition Information Element (FTIE) at least including the first key generation parameter. The authentication response message may include a second FTIE at least including the first and second key generation parameters and the checking parameter. Further, the confirm message may include a third FTIE including the first and second key generation parameters. Further, the third FTIE may optionally include an additional checking parameter generated by the first device.

In accordance with some embodiments, verifying the checking parameter of the second message may include: determining whether the checking parameter of the second message from the second device matches with a peer checking parameter generated by the first device at least based on the first key generation parameter and the second key generation parameter.

In accordance with some embodiments, the first and second key generation parameters may be used to generate a first communication key at the first device and generate a second communication key at the second device, and wherein the first and second communication keys may be respectively installed in the first and second devices for subsequent communication between the first and second devices.

In some exemplary embodiments, the checking parameter may be an integrity checking code (MIC) for checking whether the first and second communication keys are matched.

In accordance with some embodiments, the first key generation parameter may be a first Nonce of the first device, and the second key generation parameter may be a second Nonce of the second device.

In accordance with some embodiments, the first key generation parameter may be a first public key of the first device, and the second key generation parameter may be a second public key of the second device.

In accordance with some embodiments, the first message, the second message and the third message may be directly communicated between the first device and the second device, based on an over-the-air protocol.

In accordance with some embodiments, the first message, the second message and the third message may be communicated between the first device and the second device via an intermediate device connected to one of the first and second devices, based on an over-the-distribution system protocol.

In accordance with some embodiments, wherein the first and the second devices are peer-to-peer devices, the handshake process may be initiated by the first device for Simultaneous Authentication of Equals (SAE) authentication between the first and the second devices.

FIG. 10 is an exemplary block diagram illustrating a computing device in accordance with some embodiments of the present disclosure.

It should be noted that the computing device depicted in FIG. 10 can correspond to one or more of the current AP, the target AP, the current AP device, the target AP device, the current AP MLD, and the target AP MLD as described in FIGS. 1-8, and can be used to perform the actions involved in the roaming mechanism, for example, the methods 800 and 900 as described above.

As shown in FIG. 10, the computing device 1000 can comprise processor 1010 and memory 1020. The processor 1010 is communicatively coupled with the memory and configured to perform the methods discussed above.

Examples of the processor 1010 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor 1010 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 1020.

The memory 1020 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 1020 may reside in the processor 1010, external to the processor 1010, or distributed across multiple entities including the processor 1010. The memory 1020 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

In addition, according to another embodiment of the present disclosure, a computer program product for wireless communication is disclosed. As an example, the computer program product comprises a non-transitory computer readable storage medium having program instructions embodied therewith, and the program instructions are executable by a processor. When executed, the program instructions cause the processor to perform one or more of the above-described procedures, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Reference to an element in the singular is not intended to mean “one and only one” unless specifically so stated, but rather “one or more.” Similarly, reference to an element in the plural is not intended to mean “more than one” unless specifically so stated or being contradictory with the description elsewhere, but rather “one or more.” Terms such as “if,” “when,” and “while” should be interpreted to mean “under the condition that” rather than implying an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

It should be noted that the flowcharts and block diagrams in the attached drawings illustrate the possible architectures, functions and operations of the methods and apparatuses according to various embodiments of the present application. In this regard, each block in the flowchart or block diagram may represent a module, a program segment, or a part of code, which contains at least one executable instruction for implementing a specified logical function. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or by a combination of dedicated hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a first device in wireless communication comprising:
transmitting, to a second device, a first message for initiating a handshake process between the first device and the second device, wherein the first message at least includes a first key generation parameter of the first device;
receiving, from the second device, a second message as a response to the first message, wherein the second message at least includes a second key generation parameter of the second device and a checking parameter generated by the second device at least based on the first key generation parameter and the second key generation parameter; and
transmitting, to the second device, a third message for confirming a success of the handshake process, in response to verifying the checking parameter of the second message.

2. The method of claim 1, wherein the first device is a target access point (AP) device, and the second device is a non-AP device connected with a source AP device different from the target AP device, and
the method further comprising:
detecting whether the non-AP device enters into a coverage area of the target AP device,
wherein the first message is transmitted in response to detecting that the non-AP device enters into the coverage area of the target AP device.

3. The method of claim 2, wherein
the first message is an invitation message for inviting the non-AP device to transition from the source AP device to the target AP device through the handshake process therebetween;
the second message is an accept message for accepting the invitation; and
the third message is a confirm message for confirming a success of the transition.

4. The method of claim 3, wherein
the invitation message includes a first Fast Transition Information Element (FTIE) at least including the first key generation parameter;
the accept message includes a second FTIE at least including the first and second key generation parameters and the checking parameter; and
the confirm message includes a third FTIE at least including the first and second key generation parameters.

5. The method of claim 1, wherein the first device is a non-access point (non-AP) device connected with a source AP device, and the second device is a target AP device different from the source AP device, and
the method further comprising:
detecting whether a transition from the source AP device to the target AP device is needed,
wherein the first message is transmitted in response to detecting that the transition from the source AP device to the target AP device is needed.

6. The method of claim 5, wherein
the first message is an authentication request message for requesting the transition from the source AP device to the target AP device;
the second message is an authentication response message for responding to the authentication request message; and
the third message is an confirm message for confirming a success of the transition.

7. The method of claim 6, wherein
the authentication request message includes a first Fast Transition Information Element (FTIE) at least including the first key generation parameter,
the authentication response message includes a second FTIE at least including the first and second key generation parameters and the checking parameter, and
the confirm message includes a third FTIE including the first and second key generation parameters.

8. The method of claim 1, wherein verifying the checking parameter of the second message includes:
determining whether the checking parameter of the second message received from the second device matches with a peer checking parameter generated by the first device at least based on the first key generation parameter and the second key generation parameter.

9. The method of claim 1, wherein
the first and second key generation parameters are used to generate a first communication key at the first device and generate a second communication key at the second device, and
wherein the first and second communication keys are respectively installed in the first and second devices for subsequent communication between the first and second devices.

10. The method of claim 9, the checking parameter is an integrity checking code (MIC) for checking whether the first and second communication keys are matched.

11. The method of claim 1, wherein
the first key generation parameter is a first Nonce of the first device, and the second key generation parameter is a second Nonce of the second device.

12. The method of claim 1, wherein
the first key generation parameter is a first public key of the first device, and the second key generation parameter is a second public key of the second device.

13. The method of claim 1, wherein
the first message, the second message and the third message are directly communicated between the first device and the second device, based on an over-the-air protocol.

14. The method of claim 1, wherein
the first message, the second message and the third message are communicated between the first device and the second device via an intermediate device connected to one of the first and second devices, based on an over-the-distribution system protocol.

15. The method of claim 1, wherein
the handshake process is initiated by the first device for Simultaneous Authentication of Equals (SAE) authentication between the first and the second devices.

16. A method performed by a second device in wireless communication comprising:
receiving, from a first device, a first message for initiating a handshake process between the first device and the second device, wherein the first message at least includes a first key generation parameter of the first device;
transmitting, to the first device, a second message as a response to the first message, wherein the second message at least includes a second key generation parameter of the second device and a checking parameter generated by the second device at least based on the first key generation parameter and the second key generation parameter; and
receiving, from the first device, a third message for confirming a success of the handshake process, in response to verifying the checking parameter of the second message.

17. The method of claim 16, wherein the first device is a target access point (AP) device, and the second device is a non-AP device connected with a source AP device different from the target AP device, and wherein
the first message is received in case that the non-AP device enters into a coverage area of the target AP device.

18. The method of claim 16, wherein the first device is a non-access point (non-AP) device connected with a source AP device, and the second device is a target AP device, and
wherein the first message is received in case that a transition from the source AP device to the target AP device is needed for the non-AP device.

19. The method of claim 16, wherein the handshake process is initiated by the first device for Simultaneous Authentication of Equals (SAE) authentication between the first and the second devices.

20. A device for wireless communication, comprising:
one or more processors;
a memory coupled to at least one of the processors; and
a set of computer program instructions stored in the memory, when executed by at least one of the processors, the instructions perform steps of:
transmitting, to a second device, a first message for initiating a handshake process between the first device and the second device, wherein the first message at least includes a first key generation parameter of the first device;
receiving, from the second device, a second message as a response to the first message, wherein the second message at least includes a second key generation parameter of the second device and a checking parameter generated by the second device at least based on the first key generation parameter and the second key generation parameter; and
transmitting, to the second device, a third message for confirming a success of the handshake process, in response to verifying the checking parameter of the second message.
